(19) United States
(12) Patent Application Publication
(10) Pub. No.: US 2026/0030066 A1
(43) Pub. Date: Jan. 29, 2026

(54) COMPUTING SYSTEMS AND METHODS PROVIDING DECOMMISSIONING OF COMPUTING RESOURCES

(71) Applicant: Dell Products L.P., Round Rock, TX (US)

(72) Inventors: Yasemin Ugur-Ozekinci, Oakville (CA); Neetu Tripathi, Pune (IN)

(73) Assignee: Dell Products L.P., Round Rock, TX (US)

(21) Appl. No.: 18/783,503

(22) Filed: Jul. 25, 2024

(51) Int. Cl. G06F 9/50; H04L 12/46

(52) U.S. Cl. CPC G06F 9/5038; H04L 12/4641

(57) ABSTRACT

Systems and methods and computer program products support decommissioning resources in a computing system. For instance, a computing system may include a virtual private cloud or other computing system having a multitude of individual resources. A software program may identify the different individual resources, create a first graph based on the individual resources, transform the first graph to reduce a number of nodes in the graph, thereby generating a transformed graph. The software program may further create a work list based on the transformed graph and may perform decommissioning by taking tasks from the work list in parallel.

### FIELD

The present disclosure relates to computing systems and, more particularly, to systems and methods for decommissioning computing resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Further, as users have more options as to where they store their data, users may face decommissioning an old system. There is a need in the art for effective and efficient techniques for decommissioning computing resources, where those computing resources may include compute, storage and networking, encryption and/or other resources.

### SUMMARY

In various embodiments, a method includes: in response to a request to decommission a storage resource, identifying a plurality of resources included in the storage resource; generating a first directed acyclic graph based on the plurality of resources, wherein the first directed acyclic graph includes a plurality of nodes and a plurality of edges, each of the nodes representing a respective resource, and each of the edges representing a dependency among ones of the nodes; transforming the first directed acyclic graph to generate a second directed acyclic graph, including identifying a first parallel path and a second parallel path within the first directed acyclic graph and reducing the first parallel path to a first single node and reducing the second parallel path to a second single node; generating a work list based on the second directed acyclic graph, the work list including a plurality of tasks, each task of the plurality of task being associated with a dependency indication and a completion indication; and deleting a first subset of the resources, including selecting a first task from the plurality of tasks based on a first dependency indication and a first completion indication.

In various embodiments, an IHS (Information Handling System) includes: one or more processors; one or more memory devices coupled to the one or more processors, the one or more memory devices storing computer-readable instructions that, upon execution by the one or more processors, cause the IHS to: generate a first graph, the first graph representing a cloud computing resource to be decommissioned, the first graph including a plurality of nodes and a plurality of edges, each of the nodes representing a respective resource of the cloud computing resource, and each of the edges representing a dependency among ones of the nodes; transform the first graph to generate a second graph having a second plurality of nodes, including reducing a first quantity of nodes within a first path of the first graph and reducing a second quantity of nodes within a second path of the first graph; generate a work list having a plurality of tasks, each of the tasks corresponding to a respective node of the second plurality of nodes; and delete a first subset of the resources according to the plurality of tasks.

In various embodiments, a computer-readable storage device having instructions stored thereon for decommissioning a cloud resource, wherein execution of the instructions by one or more processors of an information handling system (IHS) causes the one or more processors to: receive an instruction to decommission the cloud resource; transform a first directed acyclic graph to generate a second directed acyclic graph, including replacing a first plurality of nodes on a first path within the first directed acyclic graph with a single node representing the first path; populating a work list with a plurality of tasks, wherein the work list includes a first task representing the first path, the first task further listing a plurality of resources corresponding to the first plurality of nodes, the first task further listing dependency information of the single node; select the first task for completion based upon the dependency information; and delete the plurality of resources from the cloud resource according to the task.

### BRIEF DESCRIPTION OF THE DRAWINGS

The present disclosure may be better understood, and its numerous objects, features and advantages made apparent to those skilled in the art by referencing the accompanying drawings. The use of the same reference number throughout the several figures designates a like or similar element.

FIG. 1 is an illustration of an example system, in which user may delete a system asset, according to some embodiments.

FIG. 2 is an illustration of a first directed acyclic graph, according to some embodiments.

FIG. 3 is an illustration of an example transformed directed acyclic graph, according to some embodiments.

FIG. 4 is an illustration of an example method for decommissioning a storage resource or other computing resource, according to embodiments.

FIG. 5 is an illustration of an example processing platform that may be utilized in some embodiments.

FIG. 6 is an illustration of an example processing platform that may be utilized in some embodiments.

### DETAILED DESCRIPTION

In the following description, numerous specific details are set forth in order to provide a thorough understanding of embodiments of the present disclosure. It will be apparent to one skilled in the art that embodiments of the present disclosure may be practiced without some of these specific details. Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). While embodiments of the present disclosure have been illustrated and described, the disclosure is not limited to these embodiments only. Numerous modifications, changes, variations, substitutions, and equivalents will be apparent to those skilled in the art, without departing from the scope of the disclosure, as described in the claims.

Various implementations provide systems, methods, and computer program products to decommission computing resources. In this example, computing resources may include storage resources, and such computing resources may be deployed in a cloud environment. For instance, a user may own a public cloud account, and the user may wish to delete storage system resources in their account in favor of using other instance of storage system (e.g., in another cloud or on premises resources) or simply may not need this storage system anymore and wish to release all the resources to avoid further cost. However, decommissioning computing resources may be quite difficult for a number of reasons, including identifying all the computing resources used by the storage system, and dependencies that may exist between and among the computing resources.

In one example, there may be dependencies between different cloud resource types (e.g., a virtual server or virtual machine may have a dependency to a network interface, and a network interface may have a dependency to a subnet and a security group). Dependency of each cloud resource types may be determined beforehand and published by public cloud providers, such as those that go by the names AMAZON WEB SERVICES and AZURE. In short, a dependency of a first resource to a second resource indicates that the first resource receives services (e.g., data and operational resources) from the second resource or is defined to exist underneath the second resource. As a result, a decommissioning operation may not be able to delete the second resource before deleting the first resource. In a situation in which the second resource is deleted, then the system may not be able to access the first resource to delete the first resource. Nevertheless, the first resource may continue to exist and cause a user to be charged by a cloud provider.

In one example, a first resource may become a shared resource if the user uses a same resource outside of a known framework for the first resource. For instance, a vendor, such as Dell Inc., may provide a compute and storage framework that includes a variety of different resources such as the first resource. The user may have the framework deployed in a public cloud and may also have unrelated applications deployed in the same public cloud as well. The user may also create a dependency from an unrelated application to one of the resources of the framework. In one example, the user may create a dependency between one of the user's applications and a subnet that is part of the vendor framework. In such an instance, a tool provided by the vendor may be unable to uninstall the user's application but may also be unable to delete the subnet because of the dependency. Shared resources may be difficult to identify and may cause decommissioning of the system to be complicated.

Various implementations include systems and methods to decommission computing resources, such as compute instances and storage resources. In one embodiment, a software program may identify dependencies and create a directed acyclic graph based on those dependencies. The directed acyclic graph may be complex with large number of nodes and edges, so the software program may further transform the directed acyclic graph to create a simplified directed acyclic graph that replaces some of the resources on parallel paths with a single node for a given parallel path. The software program may further create a work list based on the simplified directed acyclic graph. The work list may include a plurality of tasks, each task of the plurality of tasks being associated with a dependency indication and a completion indication. The software program may include a plurality of algorithms, configured to operate in parallel, to address tasks from the list in parallel, updating the work list as some tasks are either completed or determined to be failed (e.g., in case of a shared resource). The software program may decommission (e.g., delete or uninstall) resources associated with the tasks. The software program may also provide a list or other data structure that indicates either success or failure node-by-node or resource-by-resource for an administrator to address.

Put another way, the disclosure provides embodiments to support parallel execution of deletion of multiple resources to shorten total time of decommissioning and to mark and skip the upstream paths in case of failures. Such embodiments may transform the directed acyclic graph, representing resources to be deleted and their dependency, into a new directed acyclic graph with collapsed nodes in parallel paths without losing dependency semantic. Such embodiments may then use the transformed directed acyclic graph and its dependency ordering to find and execute respective resource deletion of nodes that can run concurrently and also expeditiously mark and skip upstream paths when encountering unrecoverable failures, such as a shared resource.

Various embodiments may include advantages over other systems. For instance, transforming the directed acyclic graph to create a simplified directed acyclic graph and then creating the work list may provide an opportunity for algorithms to work in parallel on the tasks of the work list. The parallel operation on the tasks of the work list may allow for increased efficiency in a system, for instance, by allowing the software program to complete a decommissioning operation more quickly. Furthermore, some embodiments may allow for the work list to be updated based on progress of the algorithms to decommission resources. The updated work list may then be used by the algorithms themselves to determine a next resource to decommission and may further be used by the software program to create a list or other data structure to indicate success or failure to an administrator. The list or other data structure may provide clear indications of either success or further actions to be taken to decommission.

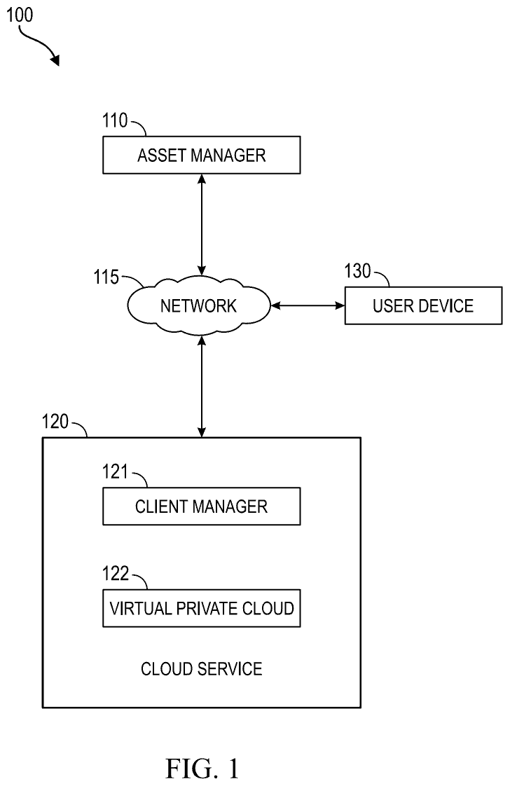

FIG. 1 is an illustration of example system 100, in which a user may delete a system asset that includes virtual private cloud 122, according to some embodiments. System 100 includes cloud service 120, which may be provided by a public cloud provider. Examples of public cloud providers include those that go by the names AMAZON WEB SERVICES and AZURE, among others. The scope of implementations is not limited to any cloud provider. A cloud service, such as cloud service 120, may include both compute infrastructure and storage infrastructure at a site that is usually removed from a user's premises. The compute infrastructure and storage infrastructure may include a multitude of servers, some directed to providing compute power, and others directed to providing storage. The servers may include one or more layers of virtualization, thereby allowing for an increased number of instances of resources when beneficial and a decreased number of instances of resources when appropriate. In other words, the infrastructure of cloud service 120 may allow for on-demand delivery of resources through virtual machines and/or containers.

In the present example, cloud service 120 hosts virtual private cloud 122. The virtual private cloud 122 belongs to a user, and that user may access virtual private cloud 122 over network 115 using a secure connection. For instance, a user may have control of user device 130, and a human user may employ user device 130 to access the virtual private cloud 122. Further in this example, the cloud service 120 is configured as a multi-tenant system, and it may host other virtual private clouds (not shown) for other users in addition to virtual private cloud 122.

Further in this example, the user may access their data and compute resources, of the virtual private cloud 122, with further services provided by a vendor. For instance, the vendor may provide convenient and effective administration and access to compute instances and storage resources on the virtual private cloud 122. In the present example, the vendor may deploy the client manager 121 in the cloud service 120 and may also provide an asset manager 110 separate from the cloud service 120. The client manager 121 and the asset manager 110 may provide the administration and access to the compute instances and storage resources on the virtual private cloud 122.

Although not shown in FIG. 1, the virtual private cloud 122 may include a multitude of different resources (also called assets). Examples of resources include, but are not limited to, a load balancer, a routing table association, a routing table, a gateway, a compute instance, a storage volume instance, a network interface, a subnet, a security group, and the virtual private cloud 122 itself. Various ones of the resources may have dependencies on other ones of the resources. Thus, should the user decide to decommission the virtual private cloud 122, the decommissioning process may necessarily be configured to navigate the dependencies. The asset manager 110 and the client manager 121 may work together to accomplish a decommissioning process, as explained in more detail below.

For instance, the client manager 121 may receive a request from the user device 130 to perform a decommissioning. In response, the client manager may update a list of resources on the virtual private cloud 122 and provide that list of resources to the asset manager 110 for validation. Upon validation, the asset manager 110 may begin the decommissioning process. The asset manager 110 may generate a transformed directed acyclic graph and a work list, perform delete operations according to tasks in the work list, update the work list, and generate a list or other data structure of the results of the decommissioning process.

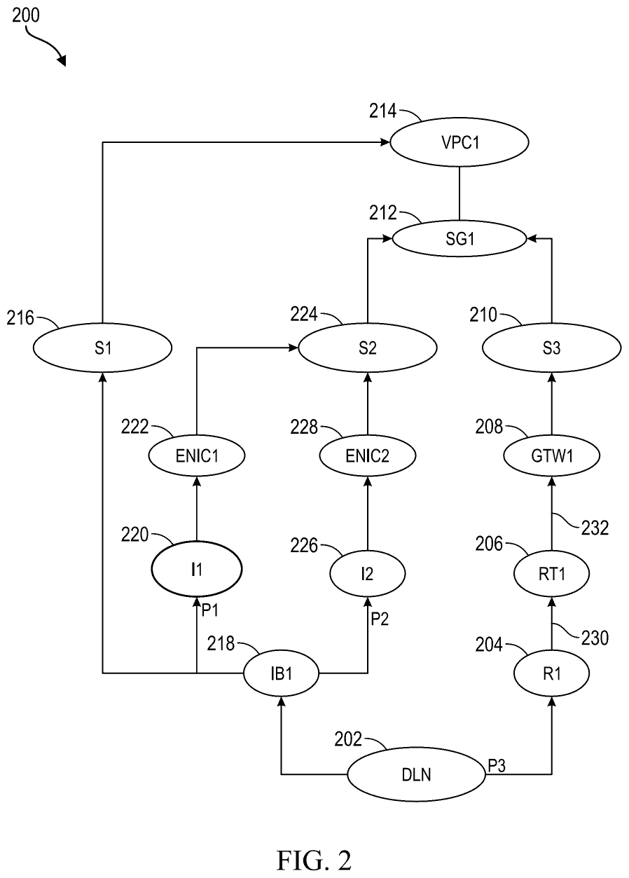

FIG. 2 is an illustration of an example directed acyclic graph 200, which may be generated by the asset manager 110 of FIG. 1, as part of a decommissioning process, according to some embodiments. The directed acyclic graph 200 represents a possible arrangement of computing resources and their dependencies, where such computing resources may be included within virtual private cloud 122.

The directed acyclic graph 200 includes a plurality of nodes 202-228 and a plurality of edges, represented by arrows. Examples of edges include edges 230 and 232. The edges each have a direction, connecting one node to another node the direction indicating a dependency. In the example of FIG. 2, the directed acyclic graph 200 does not have any closed loops caused by following the direction of the edges. In other words, there are no paths that start and end at a same node. The nodes 202-228 each represent an example resource of the virtual private cloud 122. It should be noted that the quantity of the nodes 202-228 is simplified for ease of illustration. It is generally expected that use cases may include more nodes and more edges, and the scope of implementations may be scaled to include any appropriate number of nodes and edges in a directed acyclic graph.

Starting at the top, node 214 represents the virtual private cloud 122 itself. Underneath node 214 is node 216, which represents a subnet. In this example, a subnet in virtual private cloud 122 includes a logical division of a larger network, where each subnet may provide isolation and control access to the resources underneath it. For example, an Internet protocol (IP) network may be divided into a multitude of subnets, with the subnet represented by node 216 being one such subnet.

Also underneath node 214 is node 212, which represents a security group. In this example, a security group is a logical organization for managing user accounts, computer accounts and administering user rights and permissions. Subnets are represented by nodes 224 and 210, which are both under node 212.

Thus, the node 212 and the node 216 both have dependencies on the node 214, according to the directions of the arrows. Similarly, nodes 224 and 210 both have dependencies on node 212. A node can have both incoming and outgoing dependencies, as shown by edges 230 and 232 (i.e., node 206 includes an outgoing dependency to node 208 and an incoming dependency from node 204).

Nodes 222 and 228 both represent network interfaces and have a dependency on node 224. Nodes 220 and 226 both represent compute instances and have a dependency on nodes 222 and 228, respectively. Node 218 represents a load balancer and has a dependency both on node 220 and on node 226. Of note here is that dependencies diverge from node 218 and converge to node 224.

Node 208 includes a dependency from node 210, and node 208 represents a network gateway. Node 206 has a dependency on node 208 and represents a routing table, and node 204 represents a routing table association.

Example directed acyclic graph 200 also includes a dummy leaf node 202, which does not represent any particular resource. Rather, dummy leaf node 202 is added during the creation of directed acyclic graph 200 to provide a dependency divergence at the bottom level of directed acyclic graph 200.

Asset manager 110 may generate directed acyclic graph 200 using information acquired from the validation process, mentioned above. For instance, the validation process may include an inventory of the resources in the virtual private cloud 122. Additionally, dependency information may be acquired from cloud service 120, known operating characteristics from set up of virtual private cloud 122, or other source. The asset manager 110 may generate directed acyclic graph 200 by arranging the nodes, representing resources, based on the dependency information. Furthermore, the asset manager 110 may generate directed acyclic graph 200 in response to a command to perform a decommissioning process, where the command may come from, e.g., user device 130.

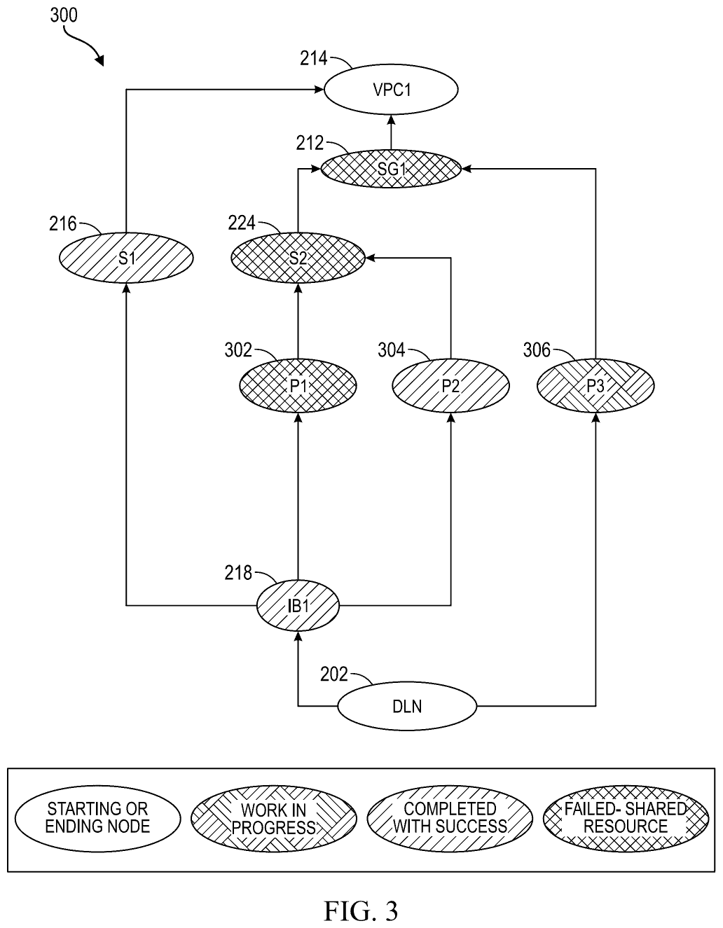

FIG. 3 is an illustration of example transformed directed acyclic graph 300, which may be generated by the asset manager 110 of FIG. 1, as part of a decommissioning process, according to some embodiments.

Specifically, once the asset manager 110 has generated the directed acyclic graph 200, the asset manager 110 may then transform the directed acyclic graph 200 by identifying parallel paths and then simplifying the nodes within those parallel paths. In this example, the asset manager 110 may identify whether a node has multiple outgoing edges and follow both of those outgoing edges until they converge to a same node. If any of the paths contain multiple non-converged nodes, then the asset manager 110 may identify that path as a parallel path.

As an example, node 202 includes multiple outgoing edges in FIG. 2, one edge going to node 204 and the other edge going to node 218. In this example, node 202 is a dummy node added by the asset manager 110 as the starting point to find parallel paths in the graph. The asset manager 110 may follow those multiple outgoing edges, which then converge at node 212. At this point, the asset manager 110 has identified at least one parallel path—the path that includes nodes 204-210. The asset manager 110 may then collapse the nodes in that path and represent the path as a single node in the transformed graph. In this example, the asset manager 110 may collapse the nodes 204-210 into a single node 306, which represents Path 3.

Continuing with the example, node 218 includes multiple outgoing edges, one edge going to node 220, and the other edge going to node 226. The asset manager 110 may follow those outgoing edges and determine that they converge at node 224. Continuing with the example, the asset manager 110 may then identify two additional parallel paths—one path which includes nodes 220-222 and another path which includes nodes 226-228. The asset manager 110 may then collapse nodes 220-222 into a single node 302 (representing Path 1) and may also collapse nodes 226-228 into a single node 304 (representing Path 2). Note that the path that includes node 216 and connects node 218 to node 214 only includes a single node (node 216). Therefore, there is nothing in that particular path to collapse. The resulting transformed directed acyclic graph 300 is illustrated in FIG. 3.

The asset manager 110 may then undertake further actions to complete the decommissioning process, once the transformed directed acyclic graph 300 has been generated. In this example, the asset manager 110 may traverse graph 300 to create a work list of tasks. A task in the work list includes a node with its incoming edges in parentheses.

A work list example is given below, and this work list example illustrates an initial work list (before any tasks have been completed) as it is derived from graph 300 by asset manager 110. Each entry in the work list represents a task.
lb1( )
p3[r1,rt1,gtw1,s3]( )
p1[i1, enic1](lb1)
p2[i2, enic2](lb1)
s1(lb1)
s2(p1, p2)
sg1(s2, p3)

The first entry (at the top) of the example work list includes the load balancer illustrated by node 218. The blank within the parentheses of the first entry indicates that the node 218 does not include any incoming edges or dependencies (e.g., no resource depends from the load balancer). In this example, the dummy leaf node 202 does not count as an incoming dependency for purposes of the work list.

The second entry in the work list represents the Path 3. The bracketed material in the second entry (“[r1,rt1,gtw1,s3]”) provides a list of the resources within Path 3. These are the resources that are represented by the nodes that were collapsed to generate node 306 in graph 300. Once again, the blank within the parentheses indicates that there no incoming dependencies to node 306.

The third entry in the work list represents the Path 1. The bracketed material provides a list of the resources within Path 1. In this example, the material in the parentheses identifies the load balancer that is represented by the node 218. Thus, Path 1 includes an incoming dependency from node 218. The fourth entry in the work list represents the Path 2, and it also indicates an incoming dependency from node 218. The fifth, sixth, and seventh entries show dependencies as well.

Continuing with the example, the asset manager 110 may include a multitude of concurrent processing units (e.g., a thread pool), where each unit may independently and in parallel access a task from the work list and operate on that task to completion or failure.

Each processing unit may then pick a task from the work list, selecting a task in which there is an indication that the dependency list is empty or is already satisfied. Assuming that a resource, represented by the task, may be deleted, then the particular processing unit may then delete the corresponding resource. Assuming that the deletion operation by the processing unit is successful, then the processing unit may save the task to a success list and update any remaining tasks in the work list, marking any dependency reference to this node as satisfied. In this example, the success list may be a same list or a different list than the work list, as success may be indicated by marking a dependency as satisfied in the work list. The work list, which is enabled by the transformed graph 300 may provide tasks (entries) that may be accessed by a multitude of processing units operating in parallel. The indications of dependency and success/failure may prevent a given one of the processing units from performing a deletion operation in an order that conflicts with dependency information.

As noted above, each processing unit may then update the work list, so that the updated work list may indicate completion and success/failure. An example of an updated work list is shown below:
p3[r1,rt1,gtw1,s3]( )
p2[i1, enic1](lb1)
p2[12, enic2](lb1)
s1(lb1)
s2(p1, p2)
sg1(s2, p3)

In this example, the processing unit, which took the first task, has completed the first task successfully and updated the work list. The updated work list has removed the first entry representing the first task. However, the other tasks remain. Further, the processing unit has updated the work list to mark completion of the deletion of the load balancer, which is represented by node 218, by underlining the parenthetical material in the entries indicating “lb1”. Thus, at this point in time, the second, third, and fourth entries have an indication of dependency, where that indication of dependency also indicates successful deletion. Such entries may be taken by one of the other parallel, independent processing units.

In some examples, deletion from the virtual private cloud 122 may include actual deletion of files and data of such resources and may further include release of compute and storage instances that were allocated to such resources. In some examples, state data of such resources may be deleted, thereby permanently deleting such resources.

If a processing unit fails to delete a resource, then that processing unit may move the entry from the work list to a failed list (or may simply mark the entry as failed in the work list). In a further example, a processing unit may take the task corresponding to Path 1 (“p1[i1, enic1](lb1)”) but determine that enic1 may not be deleted because it has a dependency to a shared resource. In this example, enic1 is a network interface represented by node 222 and collapsed into Path 1 and the node 302. For instance, there may be an application (not shown) that has an outgoing dependency to enic1, but that application may not be managed or affected by asset manager 110. In such a case, asset manager 110 may not discover the application during the earlier inventory and may not be able to delete the application. Such shared dependency may prevent the processing unit from deleting the resource enic1. Furthermore, such shared dependency may be discovered by the cloud service 120 or other tool and transmitted to the asset manager 110 during an attempt to delete the enic 1. However, the scope of embodiments may be adapted to any appropriate technique to discover shared resource dependencies. In fact, an application may be unable to be deleted by the asset manager 110 for any of a variety of reasons. For example, the owner of the application may not give permission to the asset manager 110 to discover or manage the application, or the application may be managed by a different vendor with a different toolset and as such may not be under the purview of asset manager 110.

If the resource enic1 in Path 1 cannot be deleted due to a shared resource dependency, then any resources having incoming dependencies from node 222 on Path 1 may not be deleted in this example. Continuing with the example, such scenario would cause the tasks s2(p1, p2) and sg1(s2, p3) to be un-completable.

The asset manager 110 may create a failed list, where an example of the failed list is given below:
p1, reason: dependency to shared resource: enic1 in p1
s2(p1, p2), reason: dependency to shared resource: enic1 in p1
sg1(s2, s3), reason: dependency to shared resource: enic1 in p1

If a processing unit experiences a failure to delete, such processing unit may perform one or more retry attempts before adding the task to the failed list. Furthermore, the processing unit may also add tasks identified as having incoming dependencies to failed tasks. The other independent, parallel processing units in this example will not take a task that is indicated as failed and will not take other tasks unless those other tasks in the work list have a dependency indicated as successful or have a blank dependency. The various processing units continue to take tasks and repeat the process above until all tasks have been completed successfully or moved to the failed list.

In the example of FIG. 3, various nodes are shaded to indicate starting or ending node (nodes 202 and 214), a work in progress (node 306), completed with success (nodes 218, 304, 216) and failed (nodes 302, 224, and 212). For instance, the failure of the deletion operation of the resources of node P1 prevents the resources of nodes 224 212 and 214 from being deleted as well. However, in this example, the resources of node 306 (Path 3) may be deleted successfully.

In some examples, once there are no outstanding tasks left to be taken by a processing unit in the work list, the asset manager 110 may store the failed work list and the success work list persistently to keep track of any resources that have been deleted or have been left undeleted. Such list may be provided to an administrator for visibility and reporting and, perhaps, further attempts to fix shared dependencies and reattempt decommissioning. Furthermore, the asset manager 110 may also perform attempts in the future to delete any remaining resources in the virtual private cloud 122.

Although FIG. 3 is shown as including some nodes with resources that have failed to delete, thereby preventing decommissioning of the entire virtual private cloud 122, the scope of implementations is not so limited. In another example, there may be no shared dependencies or other errors, thereby allowing for deletion of all resources in the virtual private cloud 122 (i.e., successful decommissioning).

Furthermore, while the examples above discuss resources that are on virtual private cloud 122, the scope of implementations may be expanded to include resources that are not on virtual private cloud 122. For instance, in some embodiments, client manager 121 and/or asset manager 110 may include resources that have incoming or outgoing dependencies to the resources in directed acyclic graph 200. In such examples, asset manager 110 may be configured to also include those additional resources in directed acyclic graph 200, transform directed acyclic graph 200, and perform deletion operations as appropriate. In such examples, client manager 121 and/or asset manager 110 may track those additional resources in inventory and also track dependencies of those additional resources, thereby allowing generation of directed acyclic graph 200 to include those additional resources.

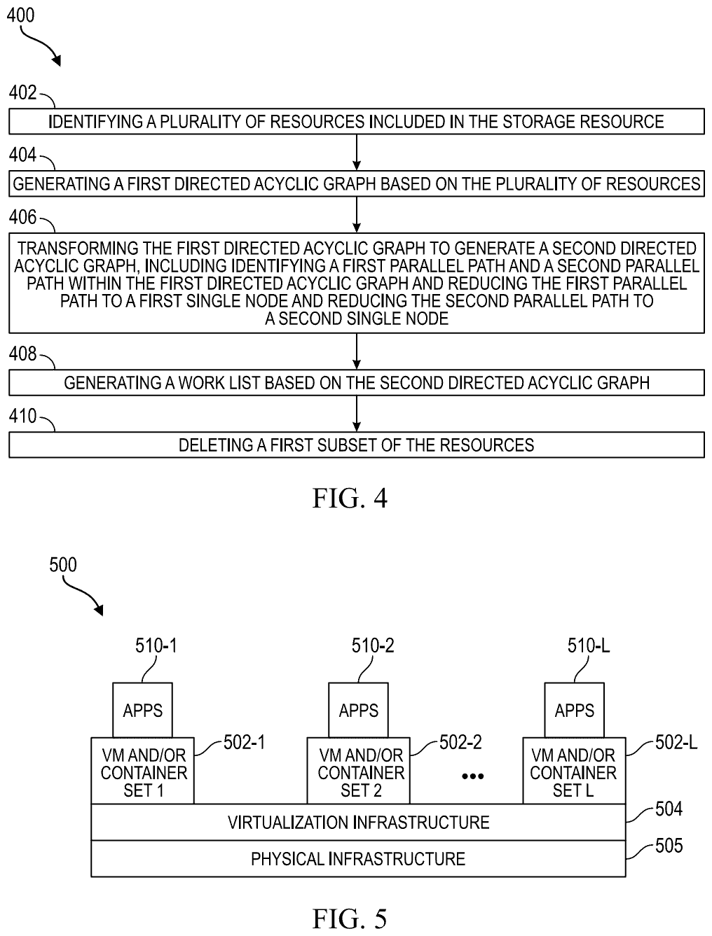

FIG. 4 is an illustration of example method 400, for decommissioning a storage resource or other computing resource, either completely or in part, according to some embodiments. Example method 400 may be performed by a software program, such as asset manager 110 and/or client manager 121 of FIG. 1. For instance, one or more processors may execute computer-readable code from a non-transitory storage medium to perform the actions of example method 400.

An example of a storage resource may include, e.g., virtual private cloud 122 of FIG. 1, where virtual private cloud 122 provides storage services for a user. It may also be appropriate to refer to virtual private cloud 122 as a compute resource, as it may also provide compute services for the user as well. In any event, virtual private cloud 122 in this example occupies a highest level in a hierarchy, such that virtual private cloud 122 includes the other resources. Nevertheless, method 400 may include decommissioning other resources, such as that may be included within asset manager 110 and/or client manager 121.

At action 402, the asset manager 110 and/or client manager 121 may identify a plurality of resources included within the storage resource. Action 402 may be performed in response to a request to decommission a storage resource. Action 402 may include performing an inventory on instantiated resources within the storage resource, performing an inventory based on information already known by the asset manager 110 and/or client manager 121, or acquiring identifying information of resources from some other sources. Action 402 may also include acquiring dependency information from any appropriate source, such as from a cloud provider. The plurality of resources included in the storage resource may include any computing resource, examples of which are provided above with respect to FIG. 2.

At action 404, the asset manager 110 and/or client manager 121 may generate a first directed acyclic graph based on the plurality of resources identified at action 402. In one example, the first directed acyclic graph may include a plurality of nodes and a plurality of edges, each of the nodes representing a respective resource, and each of the edges representing a dependency among ones of the nodes. An example of a first directed acyclic graph is shown at FIG. 2, including nodes 202-228, and example edges are shown by edges 230, 232. The first directed acyclic graph may be of any appropriate size, have any appropriate quantity of nodes, any appropriate quantity of edges, and may be acyclic.

At action 406, the asset manager 110 and/or client manager 121 may transform the first directed acyclic graph to generate a second acyclic graph. Action 406 may include identifying a first parallel path and a second parallel path within the first directed acyclic graph. Action 406 may further include reducing the first parallel path to a first single node and reducing the second parallel path to a second single node. An example of transforming the first directed acyclic graph includes the example above in which graph 200 of FIG. 2 is transformed to create graph 300 of FIG. 3. In transforming graph 200, the asset manager 110 and/or client manager 121 may reduce a quantity of nodes within some paths, replacing some nodes with a single node representing a path. For instance, in the example of FIG. 3, parallel paths Path 1, Path 2, and Path 3 are identified, and nodes within those paths are replaced by nodes 302, 304, and 306 respectively.

At action 408, the asset manager 110 and/or client manager 121 may generate a work list based on the second acyclic graph. In the examples above, the asset manager 110 and/or client manager 121 may generate a work list, where examples are given above. Each entry in the work list may be referred to as a task, and each of the tasks is associated with a dependency indication and a completion indication. In some instances, a separate success list and a separate failure list may be used to track completion indication. It is within the scope of embodiments perform action 408 by using separate lists for completion indication or tracking such information within a single work list. In other words, a work list, together with any separate lists, may be considered a work list in some implementations.

At action 410, the asset manager 110 and/or client manager 121 may delete a first subset of the resources. Action 410 may include selecting a first task from the plurality of tasks based on a first dependency indication and a first completion indication. An example is given above, in which a processing unit may take a task from the work list, where that task indicates either no incoming dependency or indicates a dependency having a completed resource deletion.

Action 410 may also include other independent and parallel processing units taking other tasks and performing resource deletion based on those tasks. In other words, action 410 may include multiple independent and parallel processing units taking tasks at the same time and attempting to complete those tasks at the same time.

Action 410 may include the independent and parallel processing units moving through the work list and attempting to complete any outstanding tasks, updating the work list as appropriate, and deleting resources as appropriate. Method 400 may result in the storage resource being decommissioned completely. In another example, method 400 may result in only a partial decommissioning of the storage resource. In either event, the asset manager 110 and/or client manager 121 may generate a list of successfully deleted resources and un-deleted resources, perhaps providing the list to an administrator, application, or other entity capable of taking action based on the list.

FIG. 5 shows an example processing platform including cloud infrastructure 500. Cloud infrastructure 500 may represent an architecture that may be adopted by cloud service 120. Furthermore, the asset manager 110 may be implemented within a cloud infrastructure, such as cloud infrastructure 500. Additionally, user device 130 may be implemented within a cloud infrastructure, such as cloud infrastructure 500. In one example, asset manager 110 may include a single application or multiple applications that are running on virtual machines or containers of cloud infrastructure 500. Client manager 121 and virtual private cloud 122 may be implemented within cloud service 120, facilitated by one or more applications that are run on a cloud infrastructure, such as cloud infrastructure 500.

The cloud infrastructure 500 may include multiple virtual machines (VMs) and/or container sets 502-1, 502-2, . . . 502-L implemented using virtualization infrastructure 504. The virtualization infrastructure 504 runs on physical infrastructure 505 and may include one or more hypervisors and/or operating system-level virtualization infrastructure. The operating system-level virtualization infrastructure may include kernel control groups of a Linux operating system or other type of operating system.

The cloud infrastructure 500 further may include sets of applications 510-1, 510-2, . . . 510-L running on respective ones of the VMs/container sets 502-1, 502-2, . . . 502-L under the control of the virtualization infrastructure 504. Furthermore, a given one of the applications 510 may correspond to asset manager 110, client manager 121, and/or an application that instantiates virtual private cloud 122 of system 100 of FIG. 1.

The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that may include at least one hypervisor.

A hypervisor platform may be used to implement a hypervisor within the virtualization infrastructure 504, where the hypervisor platform has an associated virtual infrastructure management system. The underlying physical machines may include one or more distributed processing platforms that include one or more storage systems.

In other implementations of the FIG. 5 embodiment, the VMs/container sets 502 include respective containers implemented using virtualization infrastructure 504 that provides operating system level virtualization functionality, such as support for containers running on bare metal hosts, or containers running on VMs. The containers may be implemented using respective kernel control groups of the operating system.

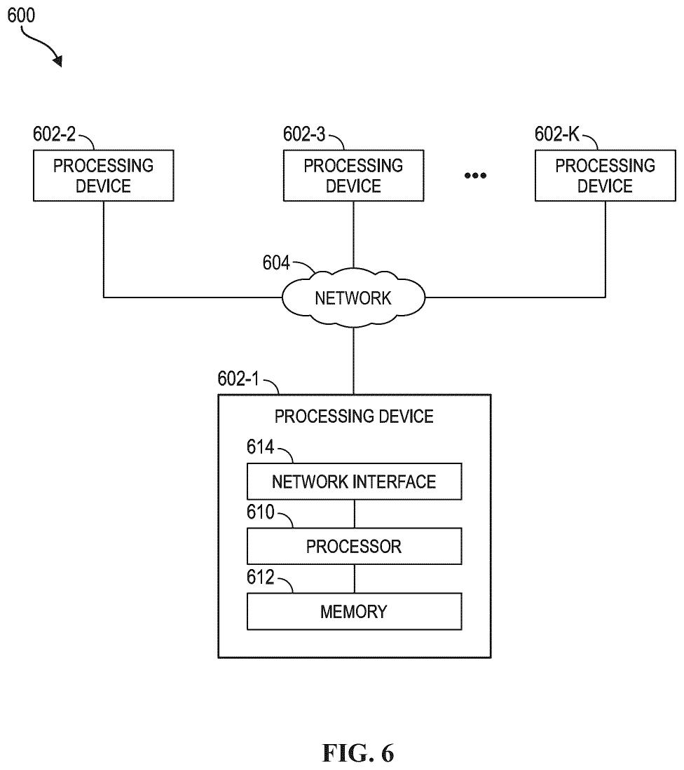

One or more of the processing modules or other components of an information processing system may each run on a computer, server, storage device or other processing platform element. A given such element is viewed as an example of a computing device. The cloud infrastructure 500 shown in FIG. 5 may represent at least a portion of one processing platform. Another example of such a processing platform is processing platform 600 shown in FIG. 6.

The processing platform 600 in this embodiment may include a plurality of processing devices, denoted 602-1, 602-2, 602-3, . . . 602-K, which communicate with one another over a network 604. For instance, user device 130 may be implemented as a processing device 602, as may one or more computing devices implementing backend functionality, such as may be used for asset manager 110. Furthermore, user device 130 may be communicatively coupled to the asset manager 110 over network 115 in the same way that computing devices 602 are coupled over the network 604.

The network 604 may include any type of network, including by way of example a global computer network such as the Internet, a WAN, a LAN, a satellite network, a telephone or cable network, a cellular network, a wireless network such as a Wi-Fi or 5G network, or various portions or combinations of these and other types of networks.

The processing device 602-1 in the processing platform 600 may include a processor 610 coupled to a memory 612. The processor 610 may include a microprocessor, a microcontroller, an application-specific integrated circuit (ASIC), a field-programmable gate array (FPGA) or other type of processing circuitry, as well as portions or combinations of such circuitry elements.

The memory 612 may include random access memory (RAM), read-only memory (ROM) or other types of memory, in any combination. The memory 612 and other memories disclosed herein should be viewed as illustrative examples of processor-readable storage media or computer-readable media storing executable program code (e.g., computer-readable instructions) of one or more software programs.

Articles of manufacture including such processor-readable storage media are considered illustrative embodiments. A given such article of manufacture may include, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products including processor-readable storage media can be used.

Also included in the processing device 602-1 is network interface circuitry 614, which is used to interface the processing device with the network 604 and other system components and may include conventional transceivers.

The other processing devices 602 of the processing platform 600 are assumed to be configured in a manner similar to that shown for processing device 602-1. Each of the processing devices 602 is an example of an information handling system (IHS). Information handling systems may include any of a variety of devices, such as servers, personal computers, smart phones, and the like. Any of the processing devices 602 may be configured to execute computer-readable instructions to perform actions associated with FIGS. 1-4.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the implementation(s) described herein embrace all such modifications and changes and, accordingly, the above description should be regarded in an illustrative rather than a restrictive sense.

Although the implementation(s) is/are described herein with reference to specific embodiments, various modifications and changes can be made without departing from the scope of the present implementation(s), as set forth in the claims below. Accordingly, the specification and figures are to be regarded in an illustrative rather than a restrictive sense, and all such modifications are intended to be included within the scope of the present implementation(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
in response to a request to decommission a storage resource, identifying a plurality of resources included in the storage resource;
generating a first directed acyclic graph based on the plurality of resources, wherein the first directed acyclic graph includes a plurality of nodes and a plurality of edges, each of the nodes representing a respective resource, and each of the edges representing a dependency among ones of the nodes;
transforming the first directed acyclic graph to generate a second directed acyclic graph, including identifying a first parallel path and a second parallel path within the first directed acyclic graph and reducing the first parallel path to a first single node and reducing the second parallel path to a second single node;
generating a work list based on the second directed acyclic graph, the work list including a plurality of tasks, each task of the plurality of task being associated with a dependency indication and a completion indication; and
deleting a first subset of the resources, including selecting a first task from the plurality of tasks based on a first dependency indication and a first completion indication.

2. The method of claim 1, wherein identifying the first parallel path and the second parallel includes identifying a divergence from a first common node of the first directed acyclic graph and a convergence on a second common node from the first directed acyclic graph.

3. The method of claim 1, wherein the first parallel path includes a first set of the nodes, and the second parallel path includes a second set of the nodes, further wherein the first set of the nodes represents a first group of the resources and the second set of the nodes represents a second group of the resources.

4. The method of claim 3, wherein transforming the first directed acyclic graph to generate the second directed acyclic graph comprises:
replacing the first set of the nodes with the first single node and replacing the second set of the nodes with the second single node; and
populating the work list so that a first task of the plurality of tasks corresponds to the first parallel path and a second task of the plurality of tasks corresponds to the second parallel path, wherein the first task references the first group of the resources and the second task references the second group of the resources.

5. The method of claim 1, further comprising:
updating the work list based on deleting the first subset of the resources.

6. The method of claim 5, further comprising:
identifying a second subset of the resources as being unable to be deleted; and
updating the work list to indicate that the second subset of the resources are not deleted.

7. The method of claim 5, further comprising:
subsequent to updating the work list, deleting a second subset of the resources, including selecting a second task from the plurality of tasks based on a second dependency indication and a second completion indication.

8. The method of claim 7, the method further comprising:
further updating the work list to indicate that all tasks of the plurality of tasks have been successfully completed.

9. The method of claim 1, wherein decommissioning the storage resource comprises decommissioning a virtual private cloud that includes the plurality of resources.

10. The method of claim 1, wherein the plurality of resources includes a compute instance and a storage volume.

11. An IHS (Information Handling System) comprising:
one or more processors;
one or more memory devices coupled to the one or more processors, the one or more memory devices storing computer-readable instructions that, upon execution by the one or more processors, cause the IHS to:
generate a first graph, the first graph representing a cloud computing resource to be decommissioned, the first graph including a plurality of nodes and a plurality of edges, each of the nodes representing a respective resource of the cloud computing resource, and each of the edges representing a dependency among ones of the nodes;
transform the first graph to generate a second graph having a second plurality of nodes, including reducing a first quantity of nodes within a first path of the first graph and reducing a second quantity of nodes within a second path of the first graph;
generate a work list having a plurality of tasks, each of the tasks corresponding to a respective node of the second plurality of nodes; and
delete a first subset of the resources according to the plurality of tasks.

12. The IHS of claim 11, wherein the computer-readable instructions to cause the IHS to delete the first subset of the resources causes the IHS to:
operate on a first one of the tasks and a second one of the tasks in parallel.

13. The IHS of claim 11, wherein the computer-readable instructions to cause the IHS to delete the first subset of the resources causes the IHS to:
take the first one of the tasks from the work list based upon first dependency information indicated in the task; and
take the second one of the tasks from the work list based upon second dependency information indicated in the task.

14. The IHS of claim 13, wherein the computer-readable instructions to cause the IHS to delete the first subset of the resources causes the IHS to:
take the first one of the tasks based upon the first dependency information indicating no dependency of a first resource listed in the first task.

15. The IHS of claim 13, wherein the computer-readable instructions further cause the IHS to:
update the work list to indicate that the first one of the tasks has been completed and that the second one of the tasks has been completed.

16. The IHS of claim 11, wherein the computer-readable instructions to cause the IHS to generate the second graph causes the IHS to:
generate the second graph as a directed acyclic graph.

17. The IHS of claim 11, wherein the computer-readable instructions further cause the IHS to:
identifying the first path and the second path as parallel paths within the first graph.

18. A computer-readable storage device having instructions stored thereon for decommissioning a cloud resource, wherein execution of the instructions by one or more processors of an information handling system (IHS) causes the one or more processors to:
receive an instruction to decommission the cloud resource;
transform a first directed acyclic graph to generate a second directed acyclic graph, including replacing a first plurality of nodes on a first path within the first directed acyclic graph with a single node representing the first path;
populating a work list with a plurality of tasks, wherein the work list includes a first task representing the first path, the first task further listing a plurality of resources corresponding to the first plurality of nodes, the first task further listing dependency information of the single node;
select the first task for completion based upon the dependency information; and
delete the plurality of resources from the cloud resource according to the task.

19. The computer-readable storage device of claim 18, further comprising instructions configured to cause the one or more processors to:
generate the first directed acyclic graph to represent resource dependency within the cloud resource.

20. The computer-readable storage device of claim 18, further comprising instructions configured to cause the one or more processors to:
select a second task for completion in parallel with the first task, including selecting the second task based upon further dependency information.
